(19) United States
(12) Patent Application Publication
(10) Pub. No.: US 2008/0202774 A1
(43) Pub. Date: Aug. 28, 2008

(54) Method of producing hypoxic environments in enclosed compartments employing fuel cell technology

(76) Inventor: Igor K. Kotliar, New York, NY (US)

Correspondence Address: IGOR K. KOTLIAR, P.O. Box 2021, New York, NY, 10159-2021, US

(21) Appl. No.: 12/079,224

(22) Filed: Mar. 24, 2008

Related U.S. Application Data
(63) Continuation-in-part of application No. 10/726,737, filed on Dec. 3, 2003.

(51) Int. Cl. A62C 39/00; H01M 8/04

(52) U.S. Cl. 169/45; 429/13; 62/78

(57) ABSTRACT

An energy-efficient method and a system for providing hypoxic environments in enclosed compartments using fuel cells that can improve their efficiency by recapturing oxygen enriched air from hypoxic generators or other air separation equipment and can contribute to establishing and/or maintaining hypoxic environments using their oxygen reduced waste gas mixture; said method and the system proposed for a use primarily in applications included, but not limited to fire prevention, food storage, heritage preservation, hypoxic training and therapy, and acclimatization.

This application is a continuation in part of the U.S. Ser. No. 10/726,737 “Hypoxic Aircraft Fire Prevention and Suppression System with Automatic Emergency Oxygen delivery System” and U.S. Pat. No. 6,560,991; U.S. Pat. No. 6,557,374; U.S. Pat. No. 6,502,421 and U.S. Pat. No. 6,401,487

### FIELD OF THE INVENTION AND PRIOR ART

The present invention introduces an energy-efficient method of producing hypoxic atmospheres within confined compartments using fuel cell technology. Hypoxic environments described in earlier patents provided above being currently used for hypoxic training and therapy, and fire prevention worldwide—sufficient information can be obtained from the patent provided above and from www.hypoxico.com and www.firepass.com.

Hypoxic generators producing such environments usually require considerable amounts of energy in order to provide air separation process on the molecular level. Usually ambient air needs to be compressed to a pressure that allows efficient separation via a membrane or molecular sieve material. Compressors require energy and they produce a lot of heat that is usually wasted. Fuel cells, however, provide new ways to producing and/or supporting hypoxic environments, which are cleaner and more energy efficient than previous methods.

Fuel cells became one of the most promising new technologies for meeting the increasing energy demand. Unlike power plants that use conventional technologies, fuel cell plants that generate electricity and usable heat can be built in a wide range of sizes—from miniature and portable units suitable for powering cell phones and automobiles, to hundreds of megawatt plants that can supply whole cities with electricity and hot water. Fuel cells produce DC power from hydrogen-rich fuel gas and air that flow over two cell electrodes. The principal byproducts are water, carbon dioxide, and heat.

Fuel cells are similar to batteries in that both produce a DC current by using an electrochemical process. Two electrodes, an anode and a cathode, are separated by an electrolyte. Like batteries, fuel cells are combined into groups, called stacks, to obtain a usable voltage and power output. However, unlike batteries, the fuel cells do not release energy stored in the cell or run down when the energy is gone. Instead, they convert the energy of a hydrogen-rich fuel directly into electricity and operate as long as they are supplied with fuel. Fuel cells emit almost none of the sulfur and nitrogen compounds released by conventional generating methods, and can utilize a wide variety of fuels: natural gas, coal-derived gas, landfill gas, biogas, or alcohols.

There are different types of fuel cells, such as alkaline fuel cells, phosphoric acid fuel cells, proton exchange membrane fuel cells, molten carbonate fuel cells, solid oxide fuel cells, direct methanol fuel cells and other types being currently in development.

U.S. Pat. No. 6,885,298, Emerson, et al, describes a fuel cell system with fire detection capability, but no fire prevention option.

U.S. Pat. No. 6,638,649, Pinney et al., teaches “A method and article of manufacture to effect an oxygen deficient fuel cell which will minimize the potential for flame and explosion occurring within an aircraft fuel tank.” However this method anticipates a use of a vessel that contains a pressurized oxygen-free gas, which makes it depended on such a vessel refilling and is not really safe for an aircraft.

Current invention allows saving considerable amounts of energy and running cost by providing a method and a system that utilize fuel cell technology for energy production and/or recovery.

U.S. Pat. No. 6,502,421 (column 4, lines 24-26) teaches: “The oxygen-enriched gas mixture can be either disposed into the atmosphere or, preferably, sent to a fuel cell that can generate electricity for the station's needs.”

U.S. Pat. No. 6,560,991 (column 4, lines 41-44) describes the use of fuel cells as follows: “The oxygen-enriched gas mixture can be disposed of into the atmosphere through outlet 28, or, preferably, send to a fuel-cell power plant that can generate electricity for the object needs.” The text in column 7, lines 55-59 teaches a more advanced use of the power cell technology: “ . . . a back-up power generator or fuel cell 64. Power generator 64 will produce a sufficient amount of electricity to power for at least several hours all of the building's emergency systems including hypoxic generator station 13 and control unit 61.”

U.S. Pat. No. 6,557,374 teaches practically the same (column 5, lines 65-67; column 7, lines 33-35) way to use the oxygen enriched fraction.

U.S. Ser. No. 10/726,737 “Hypoxic Aircraft Fire Prevention and Suppression System with Automatic Emergency Oxygen delivery System” teaches on page 8 lines 28-30: “ . . . generated using cryogenic separation of air, which is used in a new type aircraft for production of oxygen utilized for propulsion or for feeding fuel cells in marine and ground applications.”

U.S. Pat. No. 6,401,487 teaches in column 15, lines 18-21, that: “Produced oxygen will be consumed by a building's power plant, fuel cells, etc., which will allow cleaner combustion and higher efficiency of the power generating systems.”

And finally, U.S. Pat. No. 6,401,487 claims the use of the fuel cells “ . . . for producing breathable fire-extinguishing compositions” (Claim 32).

### BRIEF DESCRIPTION OF THE DRAWINGS

FIG. 1 presents a schematic view of the first preferred embodiment of the system for employing a fuel cell or a fuel cell plant for producing hypoxic fire-extinguishing atmosphere in an enclosed environment

FIG. 2 illustrates an alternate embodiment of the system for employing fuel cells for reducing oxygen content in an enclosed environment.

FIG. 3 shows a hybrid system that employs a hypoxic generator described in earlier patents and a fuel cell (or fuel cell plant) for producing and maintaining hypoxic environment in an enclosed compartment.

FIG. 4 illustrates how to protect a fuel cell itself from an ignition or fire.

### DESCRIPTION OF THE INVENTION

This reliable and low-cost solution will allow designing and building environmentally friendly, cost- and energy-efficient systems for producing and maintaining hypoxic environments in occupied and non-occupied enclosed compartments. Such compartments can be defined as fuel tanks, fuel cell enclosures, interior parts of an aircraft, transportation vehicles or a marine vessels, computer enclosures, telecommunication rooms and data centers, warehouses, and many other application where a hypoxic atmosphere being desired for fire protection, food storage, heritage preservation, hypoxic training and therapy, acclimatization and other purposes.

It is known that some types of fuel cells can utilize oxygen in order to produce electric energy. This necessity and ability to consume oxygen by fuel cells is exactly what is being employed in this invention, which resulted from the previous ideas described in earlier patent documents provided above.

A fuel cell or a fuel cell plant can work by consuming oxygen enriched air produced by hypoxic generators that generate hypoxic air for providing hypoxic environments within enclosed spaces for fire prevention or hypoxic training and/or therapy. If we look at this from another side, we can see that a fuel cell can be practically employed to reducing oxygen content within an enclosed environment using any oxygen-extraction device, as described in earlier patent documents.

The invented method and a system show practically the same process that can be viewed and named differently, depending on our main goal:
we can use fuel cells to recover energy by feeding them with oxygen as a byproduct from hypoxic generators, or
we can use fuel cells for reducing oxygen content in an enclosed space by feeding it with oxygen extracted from that space, alternatively
we can use both options to provide the most energy-efficient balance in both, hypoxic air production by hypoxic generators and electricity production by fuel cells.

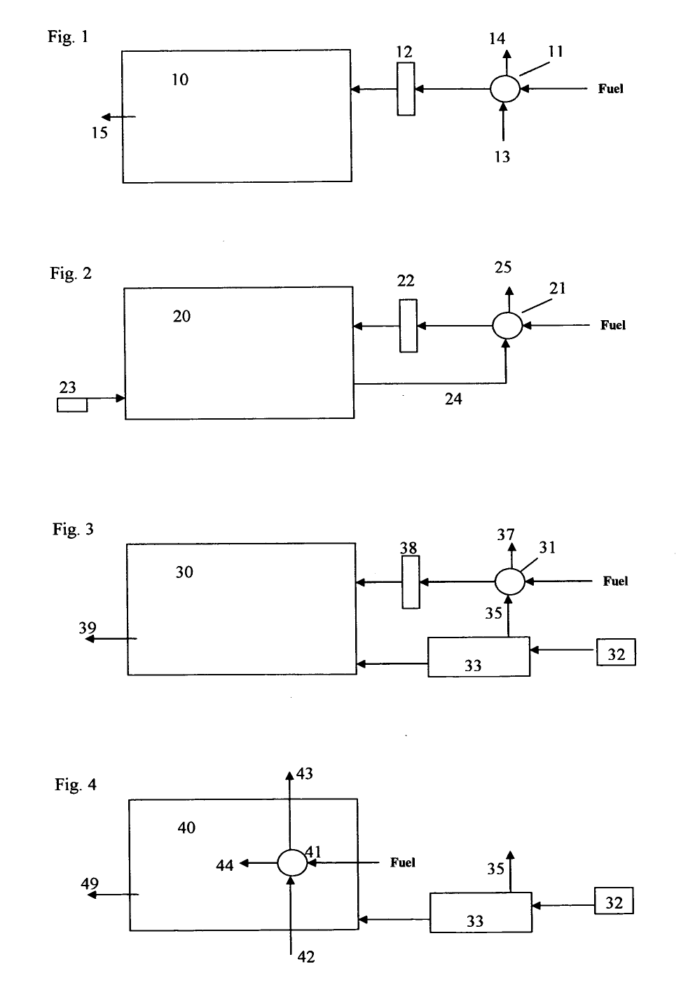

FIG. 1 shows a schematic view of an embodiment of the system for employing a fuel cell device 11, which can be a single fuel cell, fuel cell assembly or a fuel cell plant, for producing breathable fire-extinguishing compositions in an enclosed compartment 10. Fuel cell or fuel cell multiple assembly device 11 utilized fuel that can be hydrogen, methane or other hydrocarbons.

An ambient (or oxygen enriched) air being send via inlet 13 and after some of the oxygen from it being consumed by fuel cell device 11, an oxygen depleted air being send, via filtering device 12, into compartment 10. Device 11 can be fed with oxygen enriched gas mixture from a hypoxic generator or any air separation device.

For human occupied or visited compartments, device 12 can provide breathing quality hypoxic air and a control panel (not shown here) can maintain the oxygen content in compartment 10 in the range from 12% to 18%, depending on application.

An optional exhaust port 14 can be implemented for disposal of water, carbon dioxide and other contaminants that cannot be removed by the filtering device 12. In some applications, device 12 can also incorporate an air-conditioning function as well. The excessive gas mixture will leak out of the compartment 10 via existing gaps in the compartment's enclosure or through a vent 15.

The process allows ventilating the compartment 10 with oxygen reduced air or gas mixture, which can be used for, but not limited to fire prevention as described in earlier patents provided above. This method can be employed, for instance, for protection of fuel tanks in transportation vehicles and other occupied and non-occupied compartments. The filtering device 12 should be designed according to the intended use, e.g. to provide breathing quality air for occupied rooms and lower quality for fuel tanks, etc.

FIG. 2 shows an alternative use of a fuel cell or plant 21 for producing an oxygen depleted atmosphere in side compartment 20. In this case, air supply for the fuel cell 21 can be partially drawn from the compartment 20, via conduit 24, and oxygen reduced gas mixture will be send back into 20 via filtering device 22 (similar to 12). An optional exhaust 25 can be incorporated as well. In order to compensate for the internal atmospheric loss and to control oxygen content inside, an air supply device 23 being employed that can supply fresh air as needed. The device 23 should be cooperated by a control panel (not shown on the drawing) that will maintain a desired oxygen content inside. For non-occupied compartments, device 23 can be replaced by a one-way vent that will allow as much air inside as can be drawn by the pressure equalization force.

FIG. 3 shows a hybrid system that employs a hypoxic generator 33 described in earlier patents and a fuel cell (or fuel cell plant) 31 for producing and maintaining hypoxic environment in an enclosed compartment 30.

This method allows saving extensive amounts of energy for producing and maintaining a hypoxic environment, since hypoxic generator 33 will feed the fuel cell 31 with oxygen or oxygen enriched air and fuel cell 31 will, in return, produce electricity that can be utilized by the generator 33 or other devices at the facility.

A compressor 32 feeds hypoxic generator 33 with compressed air, at a pressure, necessary for air separation. As a result of the air separation, the oxygen reduced fraction then being sent into compartment 30 and oxygen enriched fraction is transmitted, via conduit 35, into fuel cell 31, having an optional exhaust 37. An oxygen reduced byproduct of the chemical reaction in the fuel cell 31 can be also sent inside of compartment 30 via filtering device 38 that is similar to device 12.

The method and the system shown on the FIG. 3 allows to providing triple effect in energy saving:
oxygen enriched fraction transmitted into fuel cell 31 allows to produce more energy
this energy can be used to partially power generator 33 or other device
oxygen reduced byproduct from fuel cell 31 allows maintaining the hypoxic environment inside compartment 30 for a longer period of time during which generator 33 can be turned off

FIG. 4 illustrates a method of protecting a fuel cell inside a hypoxic environment generated by the fuel cell itself. Fuel cell 41 being placed in an enclosed compartment 40 that is diluted or ventilated by the oxygen depleted byproduct of the fuel cell 41 expelled via exhaust 44, creating a fire preventative environment that will protect the fuel cell 41 from fire. Such a fire preventative environment should be kept below 16% of oxygen content in non-occupied spaces and between 12% and 16% for human occupied or visited compartments. Ambient or oxygen enriched air being supplied via conduit 42 and unwanted byproducts can be removed via exhaust conduit 43.

An optional hypoxic generator 33 can be added, when needed, in order to provide an additional hypoxic air flow for applications having leaky compartment 40 or when an increased ventilation rate is required, e.g. for hypoxic training or removing toxic fumes form the compartment 40. Obviously, the oxygen enriched air released from outlet 35 should be in this case transmitted into inlet 42 for improved performance of the fuel cell 41

This embodiment is particularly applicable for protecting large commercial fuel cells or fuel cell plants. It can be also implemented in transportation application, data centers and where an increased fire safety or reliability is required.

All four methods and systems employing fuel cells or fuel cell assembly can reduce risk of fire by establishing hypoxic environments with oxygen content below 18% and can prevent ignition of common materials when oxygen content can be reduced below 16%. Most applications would require control means for maintaining necessary oxygen content in such environments.

Generally, fuel cells can save energy and operate more efficiently by utilizing oxygen enriched waste gas from air separation devices and can provide or contribute to providing hypoxic fire prevention environments in such applications, but not limited to: stationary and portable power generation units or plants, auxiliary power units, transportation industry (especially fuel tanks and interior parts of automobiles, scooters, trains, airplanes, heavy construction machines, boats and other marine applications), computers, data centers and other telecommunication applications, and other fuel cell installation.

Current invention will allow to saving considerable amounts of energy and providing an exceptional level of fire safety almost in every industry and market segments.

1. A method of producing hypoxic atmospheres in an enclosed compartment, said method comprising:
an employment of a fuel cell device that utilizes a fuel and an oxygen containing gas mixture for generating electricity and releases an oxygen reduced gas mixture and other byproducts; said oxygen reduced gas mixture being transmitted into said enclosed compartment for establishing there an oxygen reduced atmosphere with an oxygen content below 18%; said oxygen reduced atmosphere being intended for a use primarily in applications included, but not limited to fire prevention, food storage, heritage preservation, hypoxic training and therapy, and acclimatization.

2. The method of claim 1 wherein said fuel cell device, consisting of a single fuel cell or a multiple fuel cell assembly, being located inside said compartment and releasing said oxygen reduced air into surrounding atmosphere inside said compartment.

3. The method of claim 1 wherein said oxygen reduced atmosphere being maintained by a control means in a range from 12% to 18% in occupied compartments and below 16% in non-occupied spaces.

4. The method of claim 1 wherein said fuel cell device utilizing an oxygen enriched gas mixture from an air separation device.

5. The method of claim 1 wherein said fuel cell device utilizing said fuel and said oxygen containing gas mixture taken form a location not communicating with said enclosed compartment.

6. The method of claim 1 wherein said fuel cell device utilizing said oxygen containing gas mixture taken form a location that is inside of or being communicating with said enclosed compartment.

7. The method of claim 1 wherein said oxygen reduced atmosphere being employed in applications included, but not limited to: stationary and portable power generation units or plants, auxiliary power units, transportation industry (automobiles, scooters, trains, airplanes, heavy construction machines, boats and other marine applications) computers, data centers and other telecommunication applications, and other fuel cell installation.

8. A system of creating a hypoxic atmosphere in an enclosed compartments, said system comprising:
a fuel cell device that utilizes a fuel and an oxygen containing gas mixture for generating electricity and releases oxygen reduced gas mixture and other byproducts; said fuel cell device having outlet for releasing said oxygen reduced gas mixture;
an enclosed compartment communicating with said outlet of the fuel cell device;
said oxygen reduced gas mixture being transmitted into said enclosed compartment through said outlet for establishing there said hypoxic atmosphere with an oxygen content below 18%;
a control means that allows to achieving and maintaining said oxygen content within desired parameters, said parameters being above 12% for occupied compartments and below 16% for non-occupied enclosed spaces.

9. The system of claim 8 wherein said fuel cell device, consisting of a single fuel cell or a multiple fuel cell assembly, being located inside said compartment and releasing said oxygen reduced air into surrounding atmosphere inside said compartment.

10. The system of claim 8 wherein said hypoxic atmosphere being maintained by a control means in a range from 12% to 18% in occupied compartments and below 16% in non-occupied spaces.

11. The system of claim 8 wherein said fuel cell device utilizing an oxygen enriched gas mixture from an air separation device.

12. The system of claim 8 wherein said fuel cell device utilizing said fuel and said oxygen containing gas mixture taken form a location not communicating with said enclosed compartment.

13. The system of claim 8 wherein said fuel cell device utilizing said oxygen containing gas mixture taken form a location that is inside of or being communicating with said enclosed compartment.

14. The system according to the claim 8 and said fuel cell device being a device utilizing a single or an assembly of fuel cells selected from the group consisting of, but not limited to alkaline fuel cells, phosphoric acid fuel cells, proton exchange membrane fuel cells, molten carbonate fuel cells, solid oxide fuel cells, direct methanol fuel cells and other types of fuel cells using oxygen for an electrochemical reaction.

15. A fire preventative composition for use in enclosed compartments, said composition being produced as a result of an electrochemical reaction inside of a fuel cell device that utilizes a fuel and an oxygen containing gas mixture; the oxygen content of said oxygen containing gas mixture being depleted by said electrochemical reaction resulting in creation of said fire preventative composition; said composition being transmitted inside said enclosed compartment for reducing and maintaining the oxygen content in the internal atmosphere of said enclosed compartment to a level below 18%.

16. The composition according to the claim 15, said composition, used in occupied compartments, being cleaned and air-conditioned to a breathing quality and having an oxygen content in a range from 12% to 18%.

17. The composition according to the claim 15, said composition, used in non-occupied compartments, having an oxygen content below 16%.

18. A method of producing hypoxic atmospheres in an enclosed compartment, said method comprising:
an employment of an air separation device capable of producing an oxygen enriched and an oxygen depleted gas mixtures from ambient air; said oxygen depleted gas mixture being transmitted into said enclosed compartment for producing there an oxygen reduced atmosphere with an oxygen content below 18%;
an employment of a fuel cell device that utilizes a fuel and said oxygen enriched gas mixture for generating electricity and releases an oxygen reduced gas mixture and other byproducts; said oxygen reduced gas mixture being transmitted into said enclosed compartment for contributing to establishing there said oxygen reduced atmosphere with an oxygen content below 18%;
said oxygen reduced atmosphere, used in occupied compartments, being cleaned and air-conditioned to a breathing quality and an its oxygen content being maintained in a range from 12% to 18%;
said oxygen reduced atmosphere for non occupied compartments having an oxygen content being maintained below 16%;
said oxygen reduced atmosphere being intended for a use primarily in applications included, but not limited to fire prevention, food storage, heritage preservation, hypoxic training and therapy, and acclimatization.

19. A system for producing hypoxic atmospheres in an enclosed compartment, said method comprising:
an air separation device capable of producing an oxygen enriched and an oxygen depleted gas mixtures from ambient air; said device transmitting said oxygen depleted gas mixture into said enclosed compartment for producing there an oxygen reduced atmosphere with an oxygen content below 18%;
a fuel cell device that utilizes a fuel and said oxygen enriched gas mixture for generating electricity and releases an oxygen reduced gas mixture and other byproducts; said oxygen reduced gas mixture being transmitted into said enclosed compartment for contributing to establishing there said oxygen reduced atmosphere;
said oxygen reduced atmosphere, used in occupied compartments, being cleaned and air-conditioned to a breathing quality and an its oxygen content being maintained in a range from 12% to 18%;
said oxygen reduced atmosphere for non occupied compartments having an oxygen content being maintained below 16%.
said oxygen reduced atmosphere being intended for a use primarily in applications included, but not limited to fire prevention, food storage, heritage preservation, hypoxic training and therapy, and acclimatization.
